(19) United States
(12) Patent Application Publication
(10) Pub. No.: US 2017/0326579 A1
(43) Pub. Date: Nov. 16, 2017

(54) DISPENSING PACKS COMPRISING COMPRESSIBLE FOAM/FIBRE INSERTS

(71) Applicant: Henkel IP & Holding GmbH, Duesseldorf (DE)

(72) Inventors: Robert J. Lambert, Dublin (IE); Harry Loughrey, Robertstown Co. Kildare (IE); Liam Patrick O'Dwyer, Celbridge (IE)

(21) Appl. No.: 15/593,390

(22) Filed: May 12, 2017

Related U.S. Application Data
(63) Continuation of application No. PCT/EP2015/079345, filed on Dec. 11, 2015.

(30) Foreign Application Priority Data
Dec. 11, 2014 (EP) 14197296.8

(51) Int. Cl. B05C 17/005; B65D 81/32

(52) U.S. Cl. CPC B05C 17/00556; B05C 17/00593; B65D 81/325

(57) ABSTRACT

The present invention relates to a system of converting dispensing packs with two or more compartments with a fixed volume to modified ratio dispensing packs or dispensing packs with one compartment to multiple compartment dispensing packs using modified compressible foam or fibre inserts.

### BACKGROUND

### Field

The present invention relates to a system of converting dispensing packs with two or more compartments with a fixed volume to modified ratio dispensing packs or dispensing packs with one compartment to multiple compartment dispensing packs using modified compressible foam or fibre inserts.

### Brief Description of Related Technology

Syringes (or cartridges or other dispensing devices) providing one, two or multiple compartments are commercially available. In case of two- or multiple-compartment syringes, the compartments are typically fashioned to contain liquid (including gel-like) solutions, dispersions and the like, which are spatially separated from one another. Conventionally, two- or multiple-compartment syringes contain and release their contents in a 1:1(:1:1 . . . )-ratio (relative to the volume). Compared to two- or multiple-compartment syringes providing for different volume ratios, 1:1 volume ratio syringes are rather inexpensive, but suffer from diminished dispensing volume variability. Apart from varying compartment volumes, the release ratio of two- or multiple-compartment syringes can be adjusted to a certain extend by application of static mixer connection or transition pieces, which are available in different embodiments and vary in their applicability for certain liquids as well as in complexity and production costs. A general demand for ratio variability combined with a broad field of application and maintained cost-effectiveness prevails.

### SUMMARY

The present invention meets this need and provides a system, which allows easy conversion of identical-ratio dispensing packs to variable-ratio packs using inexpensive, inert, compressible foams or fibres that are to be inserted into at least one of the compartments, whereby the volume of the respective compartment becomes individually adjustable. Furthermore, in certain embodiments, these compressible foams or fibres comprise variable hollow chambers, which form distinct compartments in the foam or fibre inserts, enabling variable dispensing ratios of different liquids in one-, two- or multiple-compartment dispensing packs.

In a first aspect, the present invention thus relates to a dispensing pack comprising two or more (multiple) spatially separated compartments, wherein one or more of the compartments contain a compressible foam or fibre insert to modify the volume of the compartment.

In another aspect, the present invention relates to a method for varying the dispensing volume ratio of a dispensing pack comprising two or more compartments by inserting one or more compressible foam or fibre inserts into one or more of the compartments.

In a further aspect, the present invention relates to a dispensing pack comprising one or more spatially separated compartments, wherein at least one of the one or more compartments contains at least one compressible foam or fibre insert, wherein the insert is designed such that it defines one or more spatially separated compartments.

In yet another aspect, the present invention is also directed to a method for varying the dispensing volume ratio of dispensing packs comprising one or more spatially separated compartments by inserting at least one compressible foam or fibre insert into at least one of the one or more compartments, wherein the at least one compressible foam or fibre insert is designed such that it defines one or more spatially separated compartments.

### BRIEF DESCRIPTION OF THE DRAWINGS

FIG. 1 is a front elevational view of a dual, two compartment syringe containing a compressible foam insert.

FIG. 1 detail A is an enlarged view of a portion of FIG. 1.

FIG. 2 is a front elevational view of the dual, two compartment syringe of FIG. 1 with the plunger lowered.

FIG. 2 detail B is an enlarged view of a portion of FIG. 2.

FIG. 3 depicts front perspective views of a dual, two compartment syringe containing a compressible foam insert with the plunger in the raised (S1) and partially lowered (S2) positions.

### DETAILED DESCRIPTION

“One or more” or “at least one”, as interchangeably used herein, relates to 1, 2, 3, 4, 5, 6, 7, 8, 9 or more of the referenced species. Similarly, “two or more”, as used herein, relates to 2, 3, 4, 5, 6, 7, 8, 9 or more of the referenced species.

In the context of the present invention, the term “dispensing pack” is meant to include all types of containers that can dispense a liquid, including syringes, cartridges and other devices suitable for dispensing purposes.

The term “inert”, as used herein, means that no chemical reaction occurs between the two referenced materials, i.e. the respective materials remain unchanged even after prolonged contact with each other.

The term “liquid”, as used herein, includes all liquid materials, such as solutions, dispersions, emulsions, etc., or other compositions exhibiting appropriate viscosity, which would possibly be subject to dispensing needs. The term as used herein also includes gel-like materials, as long as they are dispensable using the devices disclosed herein.

“Essentially the same”, as used herein in relation to a given variable such as volume, means that the variables it refers to differ by no more than 10%. Essentially the same volume thus means that the two volumes are identical to each other with a variability of ±10%.

The benefits of this invention are achievable with essentially all types of one- or two-compartment liquid dispensing packs, such as syringes, cartridges or other types of dispensing devices. Devices fashioned to contain and dispense liquids typically consist of inert materials such as plastic or glass to avoid reaction of the container surface with the liquid to be contained therein. Two- or multiple-compartment dispensing packs are constructed to enable containment of two or more liquids in a single dispensing pack, wherein the respective liquids are kept spatially separated by two or more individual tubes. Moreover, two- or multiple-compartment dispensing packs usually comprise static mixer connection pieces, which blend the liquid contents prior to their release through the bottom opening of the dispensing pack. In general, multi-compartment packs comprise spatially separated compartments of essentially the same volume, but may also comprise multiple, spatially separated compartments of different volumes.

In various embodiments, the dispensing pack thus comprises one or more compartments, each having the form of a tube, for example made of glass or plastic, and each having an inlet (opening) and an outlet (opening). For allowing dispensing the liquids contained therein, each tube may be equipped with a glass or plastic plunger that fits tightly into said tube to allow dispensing the liquid contained therein by moving the plunger from the inlet opening to the outlet opening, thus forcing the liquid to exit the tube at the outlet. The outlet of the separate tubes, in case the pack is a multiple compartment pack, may be connected (or fitted) to a static mixer. Said static mixer may then mix the liquids in the dispensing process.

Certain embodiments of the present invention relate to compressible foam or fibre inserts, which transform dispensing packs, comprising two or more spatially separated compartments of essentially the same volume, into variable ratio dispensing packs, for example syringes. The insertion of inert, compressible foams or fibres allows for volume adjustment of either one or more of the tubes of 1:1(:1:1 . . . )-ratio syringes. This is due to the fact that the foam or fibre insert has its own volume and thus reduces the overall volume of the compartment containing said insert by its own volume. Due to its compressibility any liquid in the compartment soaked up by the insert can be released upon the dispensing process, if the foam or fiber insert is compressed, for example by a plunger. For example by using a foam or fiber insert that has 90% of the volume of the compartment into which it is placed, a 1:1 volume ratio syringe can be converted into a 1:10 volume ratio syringe. The compressibility of the inserts thus allows for changes in compartment volume and, in the process of dispensing, release of the liquid content with as little as possible liquid wastage.

The inserts can be selected individually and according to particular demands. Depending on the volume required, not only the size but also the density of respective insert can be taken into account. “Density”, as used in this context, relates to the porosity of the fiber or foam insert and is a measure for its liquid storage capability. Highly porous foam or fiber inserts, for example, can soak up higher volumes of liquid than denser, less porous foams and fibres. Depending on physical and chemical properties of the liquids to be, for the sake of dispensing, contained in the tubes, different types of insert materials are available and can be chosen from.

Compressible foams or fibres can also be inserted into one-compartment dispensing packs, such as syringes, but also into multiple-compartment dispensing packs of not essentially identical tube volumes. In such embodiments, the respective inserts contain one or more hollow spaces that define spatially separated compartments, for example a middle chamber. The walls of such a compartment within the insert may be impermeable for liquids or at least the liquids to be contained therein. Such impermeability for the liquids contained in the insert compartment prevents mixing of the liquids contained in the pack compartment containing the insert. Such embodiments allow for volume ratio modification of, for example, one-compartment syringes and their conversion into multiple compartment packs, such as to allow dispensing more than one liquid that are, before dispensing, kept in separate compartments.

In various embodiments, such inserts may have the form of a tube, with the foam or fibre material forming a circumferential wall enclosing a hollow middle chamber and having openings at the top and the bottom. The wall may be impermeable or even impenetrable for the liquid contained in the hollow middle chamber and the liquid contained in the (outer) device compartment. In various other embodiments, the insert may have the form of a tube, but define more than one spatially separated chambers, that may be arranged concentrically or may be separated by walls extending parallel to the tube wall.

The compartments defined by the insert may differ in volume from the residual volume of the dispensing pack compartment containing the insert. Alternatively, they may be of a similar or identical volume. By using such inserts, a one-compartment dispensing device may, depending on the volume of the insert compartment, be converted into a variable volume ratio multiple-compartment dispensing pack.

Materials suitable for preparation of foams as used in accordance with the present invention comprise for example polymers and polymer-compositions generally known in the art, such as, without limitation, polyurethane, polyester, polyolefin, polystyrene, synthetic and natural latex, natural and synthetic resin, and polymer nano-composites.

Suitable materials for fibre-composites, as used in accordance with the present invention, comprise for example, without limitation, cotton, wool, hemp, flax, sisal, ramie, bagasse, carbon-, silica- or basalt-based materials, cellulose, glass wool, mineral wool, polyurethane, polyester, polyolefin, polyamide, and mixtures thereof.

Preferably, the respective compressible foam or fibre inserts are chemically inert towards the liquids they are contacted with. Accordingly, the respective foam or fibre inserts can be chosen according to their own and the respective liquid's chemical properties, and by doing so, the possibility of chemical reactions between the insert material and the liquids to be contained therein can be minimized.

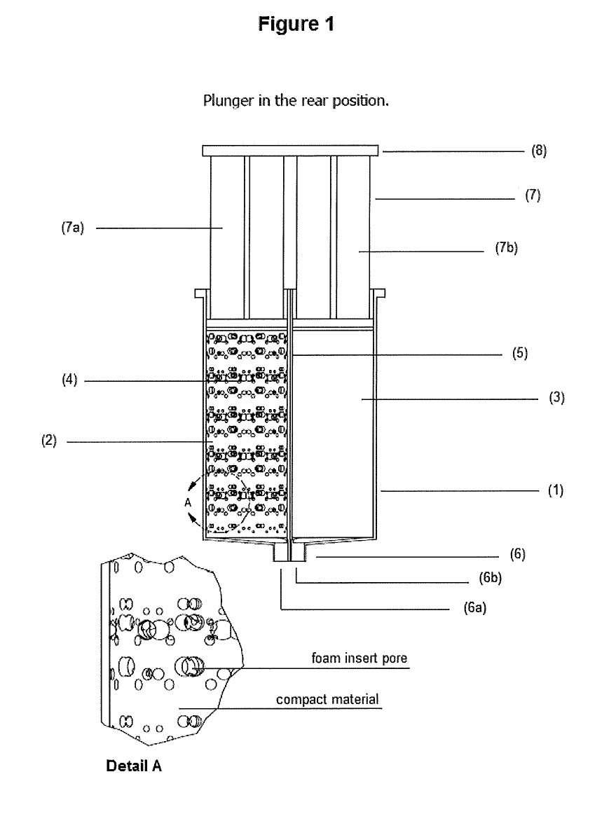

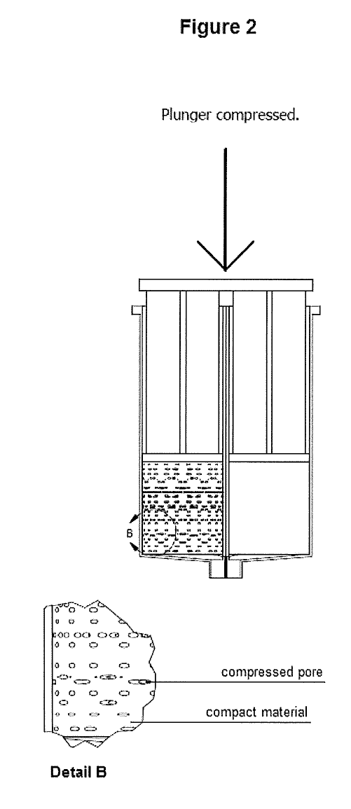

A dual, two compartment syringe (1) containing a compressible foam insert (4) in one of its two compartments according to various embodiments of the present invention is schematically depicted in FIGS. 1 and 2. These Figures are provided for illustrative purposes only and the invention shall not be construed as being limited thereto. Generally, FIG. 1 shows a dual, two-compartment syringe with plunger appliance and compressible foam insert. In more detail, the reference sings relate to the following: (1) dual two-compartment syringe; (2) syringe compartment A; (3) syringe compartment B; (4) compressible foam insert; (5) inner syringe compartment wall; (6) syringe outlet; (6a) syringe outlet connected to compartment A; (6b) syringe outlet connected to compartment B; (7) plunger; (7a) plunger for compartment A; (7b) plunger for compartment B; (8) plunger connector, connecting and securing plunger (7a) and plunger (7b); Detail A of FIG. 1 depicts pores and compact material of the foam insert (4).

In FIG. 1, the plunger (7) is positioned at the rear position of the syringe inlet. Compartment A (2) contains a compressible foam insert (4) according to the present invention and, in addition, is filled with a liquid A. This liquid A is soaked up by the compressible foam insert (4) due to its porous structure, which is depicted in Detail A of FIG. 1. The density of the compressible foam insert (4), which depends on the foam's ratio of pores to compact material, determines and limits the total amount of liquid that can be contained in the foam-filled syringe compartment A. The porous structure of the collapsible foam insert (4) is graphically depicted in Detail A of FIG. 1. As shown by FIG. 1, the foam insert (4) may occupy the entire tubular, inner space of the syringe compartment A (2). The two individual compartments (2) and (3) of the depicted syringe (1) are spatially divided from each other by an inner syringe compartment wall (5), that is, the liquid A contained in the first, foam-filled compartment (2), is, for the time of its containment inside the dual syringe (1), not mixed with the liquid B, which is contained in the second compartment B of the depicted syringe (1). Only upon discharge of both liquids, e.g. by pushing down the plunger (7), liquid A and liquid B are contacted with each other at the outlet (6) of the syringe (1). This outlet (6) comprises two individual openings (6a) and (6b), of which one of each is connected to one of the two separate syringe compartments (2) and (3) enabling discharge of the liquids from their respective storage compartments.

FIG. 2 schematically illustrates how, upon lowering of the plunger appliance (7), the volume inside both compartments A (2) and B (3) is reduced and the compressible porous structure of the foam insert (4) collapses due to the increased pressure exerted thereon by the plunger appliance (7). FIG. 2 generally shows the dual, two-compartment syringe of FIG. 1 with plunger appliance lowered halfway down and compressed foam insert. Detail B of FIG. 2 depicts the compressed, squeezed pores of the foam insert. Lowering of the plunger (7) down the syringe compartments (2) and (3) results in a volume reduction in both compartments by the same amount. This means, for instance, that in case of a foam insert (4) occupying the first syringe compartment A (2) and reducing the compartment's overall volume to 50% of its total volume as depicted in FIG. 1 by lowering of the plungers (7a) and (7b) halfway down both syringe compartments A and B, 50% of liquid A and 50% of liquid B are discharged as depicted in FIG. 2. Compressing the foam insert (4) by lowering of the plunger appliance (7) squeezes the liquid A contained inside the pores of the foam insert (4) out, down the syringe compartment A (2) and out of the syringe opening (6a). The total amount of liquid A discharged depends on pore size of the foam insert and size of the compartment (2), while the total amount of liquid B discharged depends only on the size of the compartment (3).

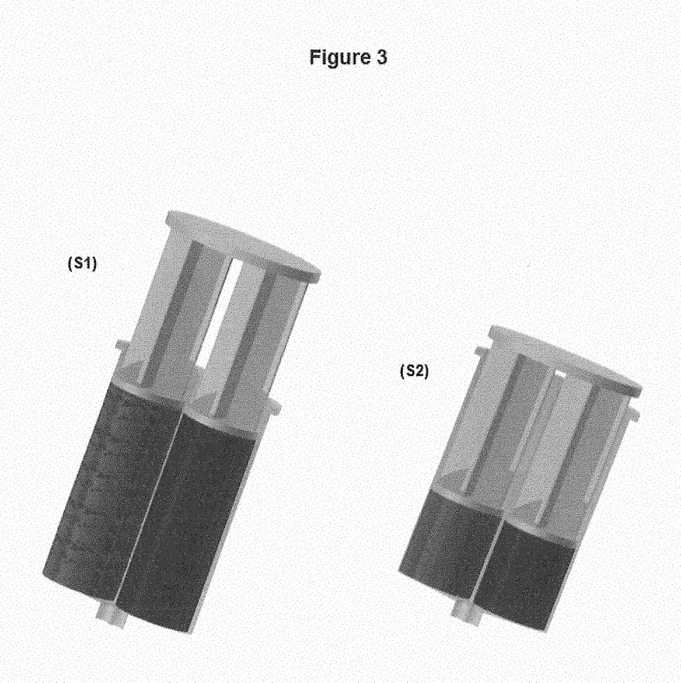

FIG. 3 shows a three-dimensional, shaded illustration of a dual two-compartment syringe according to one embodiment of the invention with compressible foam insert in one of its compartments with plunger appliance in rear (S1) and halfway down lowered position (S2).

### EXAMPLE

Testing has been carried out with samples of foam from UXEM Flexible foams B.V. Lelystad, The Netherlands. Syringes were filled with foam of different densities and water. The syringes were then dispensed 1 ml at a time and the weight recorded. For a number of foams each 1 ml dispensed related to 1 g of water. For a two-component system, this would mean that foams of different densities would dispense 50% volume for 50% stroke of the plunger. By changing the density of the foam this would modify the volume of the syringe compartment to be occupied by the foam insert. For example, a 1:1 syringe can be used as a 2:1 syringe in case a foam insert is used, which reduces the overall available volume of the syringe compartment it occupies to 50% of its total volume (see FIGS. 1 to 3). The density of the foam can be tuned to give a varying dispense ratio. Hence, by using a 1:1 syringe, different foam insert may be used to obtain different dispensing ratios, thus allowing the use of cheaper and more widely available syringe formats and also giving greater design freedom when developing products.

What is claimed is:

1. A dispensing pack comprising two or more spatially separated compartments, wherein one or more of the compartments contain a compressible foam or fibre insert to modify the volume of the compartment.

2. A method for varying the dispensing volume ratio of a dispensing pack comprising two or more compartments by inserting one or more compressible foam or fibre inserts into one or more of the compartments.

3. The dispensing pack or method according to claim 1, wherein the two or more compartments have essentially the same volume.

4. The dispensing pack or method according to claim 1, wherein the dispensing pack comprises two or more foam or fibre inserts, wherein the two or more foam or fibre inserts differ in volume and/or density.

5. The dispensing pack or method according to claim 1, wherein the two or more spatially separated compartments have the form of two or more glass or plastic tubes each having an inlet and an outlet and each being equipped with a glass or plastic plunger fitting tightly into said two or more tubes, and the dispensing pack optionally further comprise a static mixer suitable for mixing the components contained in the dispensing pack in the dispensing process, said static mixer being connected to the outlet of said two or more tubes.

6. A dispensing pack comprising one or more spatially separated compartments, wherein at least one of the one or more compartments contains at least one compressible foam or fibre insert, wherein the insert is designed such that it defines one or more spatially separated compartments.

7. A method for varying the dispensing volume ratio of dispensing packs comprising one or more spatially separated compartments by inserting at least one compressible foam or fibre insert into at least one of the one or more compartments, wherein the at least one compressible foam or fibre insert is designed such that it defines one or more spatially separated compartments.

8. The dispensing pack or method according to claim 6, wherein the one or more spatially separated compartments defined by the insert
(1) are designed such that mixing of the components contained in the compressible foam or fibre insert with the components contained in the dispensing pack compartment is essentially prevented; and/or
(2) differ in volume from the residual volume of the dispensing pack compartment containing the insert.

9. The dispensing pack or method according to claim 6, wherein the one or more spatially separated compartments have the form of one or more glass or plastic tubes each having an inlet and an outlet and each being equipped with a glass or plastic plunger fitting tightly into said one or more tubes, and the dispensing pack optionally further comprise a static mixer suitable for mixing the components contained in the dispensing pack in the dispensing process, said static mixer being connected to the outlet of said one or more tubes.

10. The dispensing pack or method according to claim 1, wherein the compressible foam insert comprises or consists of a material selected from the group consisting of polyurethane, polyester, polyolefin, polystyrene, synthetic and natural latex, natural and synthetic resin, or mixtures thereof.

11. The dispensing pack or method according to claim 1, wherein the compressible fibre insert comprises or consists of a material selected from the group consisting of cotton, wool, hemp, or other natural fibres, carbon-, silica-, and basalt-based materials, cellulose, glass or mineral wool, polymer-based materials such as polyurethane, polyester, polyolefin, or polyamide, or mixtures thereof.

12. The dispensing pack or method according to claim 1, wherein the compressible foam or fibre insert is essentially inert towards the liquids contained in the compartment.
